(19) United States
(12) Patent Application Publication
(10) Pub. No.: US 2026/0341995 A1
(43) Pub. Date: Oct. 29, 2026

(54) PLUG-IN CONNECTOR ARRANGEMENT AND PLUG-IN CONNECTOR

(71) Applicant: Robert Bosch GmbH, Stuttgart (DE)

(72) Inventor: Manfred Moser, Reutlingen (DE)

(21) Appl. No.: 19/123,318

(22) PCT Filed: Oct. 31, 2023
(86) PCT No.: PCT/EP2023/080354

§ 371 Date: Apr. 22, 2025

(30) Foreign Application Priority Data
Oct. 31, 2022 (DE) 10 2022 211 544.9

(51) Int. Cl. H01R 13/24; H01R 13/639

(52) U.S. Cl. CPC H01R 13/2457; H01R 13/2492; H01R 13/639

(57) ABSTRACT

A plug-in connector arrangement. The arrangement includes a plug-in connector and a mating plug-in connector. The plug-in connector includes a contact chamber with an outer wall, and a lamella cage having a base element, a plurality of contact lamellae, and a coupling section. The contact lamellae include a contact-making section. The lamella cage is arranged in the contact chamber. The contact-making sections are pre-bent in the direction of the outer wall in relation to a rear section and a front section of the contact lamellae. The mating plug-in connector includes a contact element having a bottom side. The mating plug-in connector can be displaced at least as far as a first position with a force of less than 5 N along an insertion direction. In a second position of the mating plug-in connector, the contact element makes mechanical contact with the coupling section of the lamella cage.

### FIELD

The present invention relates to a plug-in connector arrangement and a plug-in connector.

### BACKGROUND INFORMATION

Plug-in connector arrangements typically comprise a plug-in connector and a mating plug-in connector that can be plugged together. Plug-in connectors for high-current applications (e.g., for electrical currents of more than 10 A, preferably of more than 50 A or even more than 100 A), e.g., for electric vehicles or for automotive applications, often comprise contact elements with spring lamellae, e.g., toroidal or sleeve-shaped lamella cages, which are connected to a (e.g., shielded) cable by means of a mechanical crimp connection or by means of ultrasonic welding. In other cases, the lamella cages can also be connected, e.g., soldered or by means of a press-fit contacting, directly to a carrier element, e.g., a printed circuit board. Such plug-in connectors are designed to be connected to a mating plug-in connector, which can comprise a contacting part, e.g., in the form of a contact pin or a contact blade or the like. The connector can be plugged together with, e.g., the mating plug-in connector along an insertion direction or a plug-in direction. In a final state, a contact element of the mating plug-in connector (also referred to as a mating contact element) electrically contacts the contact element of the plug-in connector. The spring lamellae of the contact element of the plug-in connector should exhibit a normal force (or contact normal force) in the final plugged-together state, which ensures an electrical connection to the mating contact element even under mechanical and/or thermal load and across all manufacturing tolerances.

However, this normal force is usually limited, since the plug-in forces when connecting the plug-in connector to the mating plug-in connector should not exceed a defined level. In order to reduce the high insertion forces for an operator, lever designs or slider designs can be provided, e.g., so that the operating force when plugging together is reduced. However, such lever or slider designs are often complex and expensive and require a large amount of movement for operation and do not prevent damage to the surfaces rubbing against each other when the contact element of the mating plug-in connector slides along the contact lamellae. It is possible to reduce the plug-in forces by applying a friction-reducing coating to at least one contact partner (contact element and/or mating contact element) and also to reduce damage to the surfaces during the plug-in process. However, this increases the cost and complexity of the production process of the corresponding contact partner and does not reliably prevent damage to the surfaces of the contact partners. In addition, as a result under certain circumstances this can increase contact resistance in the region of the contact point.

In other applications, the contact partners (contact element and mating contact element) can be designed as, e.g., busbars. These can, e.g., be screwed together to ensure permanent contacting. When screwing with M4 screws, e.g., a so-called contact force or normal force in the range of 2000 N to 2500 N can be achieved. If M5 or M6 screws are used, even higher normal forces can be achieved. However, such a screw connection of the contact partners requires additional installation space for arranging the screws and the means to tighten or loosen the screws in the event of maintenance. In addition, multiple additional steps are necessary before and/or after the contact partners are plugged together, which makes the assembly process complex: the contact partners must be precisely aligned relative to each other in order to be able to tighten the screw, the screw must be placed in position, a tool for tightening the screw must be placed in position, the screw must be tightened, the tool must be removed.

German Patent Application No. DE 10 2018 202 960 A1 describes a plug-in connector for automotive applications and/or high-current applications in which the contact element is designed as a lamella cage. In order to reduce the high plug-in forces (between contact element and mating contact element) that occur for an operator during the plugging together process, a lever element is provided which is actuated during the plugging together process when the plug-in connector and mating plug-in connector are plugged together.

German Patent Application No. DE 10 2017 213 093 A1 describes a plug contact for high current applications, wherein the contact element is designed as a lamella cage and in which a high insertion force (between contact element and mating contact element) must be overcome during the insertion of a mating contact element into the contact element.

German Patent Application No. DE 10 2019 131 791 A1 describes a contact element of a plug-in connector, wherein the contact element is directly connected to a printed circuit board and wherein the contact element can be contacted by inserting a pin-like contact element of a mating plug-in connector.

German Patent Application No. DE 20 2008 005 394 U1 describes a high-current printed circuit board connector with a lamella cage, wherein the connector can be pressed into a printed circuit board by means of a plug-in base and can as a result be electrically contacted.

PCT Patent Application No. WO 2007/107 208 A1 describes a plug-in connection of the Radsok type (Radsok connector) with a socket of the Radsok type (Radsok socket) and a plug that can be plugged into the socket, which form a plug-in connector arrangement when plugged together, wherein locking means are formed on the Radsok socket and the plug which allow a defined fixing of the Radsok socket and plug.

### SUMMARY

The present invention is based on the finding that if a low normal force is present (at the contact point(s) between the contact element and the mating contact element) in the event of high temperature fluctuations and/or strong vibration or shaking loads, there is a risk that undesirable relative movements between the contact partners (contact element and mating contact element) and/or contact interruptions may occur. Furthermore, the present invention is based on the finding that for a long service life of the contacting and/or for low heating of the contact point when transmitting high currents, the largest possible contact surface between the contact partners is useful. Furthermore, the present invention is based on the finding that high insertion forces during a large portion of the path when plugging together the plug-in connector and mating plug-in connector complicate the plugging process. Furthermore, the present invention is based on the finding that the application of the normal force between the contact element and the mating contact element, in particular when these are in the form of a socket contact (female contact element) and a contact pin or contact blade (male mating contact element), already during the plugging process—i.e., on the path or a large part of the path, e.g., more than 30% of the way, e.g., from a pre-plugging position via an intermediate plugging position (first position) to a final plugging position (second position)—not only complicates and makes the insertion process more difficult, in particular when a plurality of plug-in connectors are plugged together with a plurality of mating plug-in connectors at the same time, but in addition the surfaces of the respective contact partners can also be affected. If the normal force is applied during the plugging process, e.g., a contact lamella can leave a grinding mark or a scratch on a contact part to be contacted. This can undesirably damage or destroy a surface coating and can be detrimental to repeated plugging together and unplugging, since such scratches or grooves can effect the contact partner getting stuck during the plugging together or unplugging process. A high insertion force (between the contact partners) can reduce the number of contact partners in a plug-in connector even in an undesirable way, since with a high number of contact partners the insertion forces can become so high, even when lever or slider designs are used, that the operating force is no longer reasonable for an operator. Furthermore, the present invention is based on the finding that the coating of the contact partners can reduce the current carrying capacity and increase the costs. Finally, the present invention is based on the finding that lamella cages which are firmly connected, in particular by means of a material bond or by being pressed into a chamber, to or in or on the plug-in connector can lead to a defective lamella cage resulting in total economic loss of the plug-in connector, since the lamella cage cannot be replaced at a reasonable cost. This affects sustainability.

There may therefore be a need to provide a plug-in connector arrangement that allows the connection or plugging together of a plug-in connector with a mating plug-in connector (which may also be designed, e.g., as a pin header or the like) with the lowest possible plug-in force, which at the same time comprises a high normal force between the contact partners in the electrically contacted state, which comprises a high current-carrying capacity, which provides the largest possible contact surface between the contact partners, which allows a permanent, safe, reliable, and uninterrupted electrical contacting between the plug-in connector and mating plug-in connector even under alternating thermal loads and/or mechanical loads such as, e.g., vibration loads or shaking loads, which requires only a small installation space or assembly space for the contacting process, which allows safe operation (no risk of contact with live parts), in which at least the contact partners (contact element and mating contact element) can be manufactured cost-effectively and easily, in which the establishment of the contacting with the desired normal force is possible in a simple manner with as few steps as possible, even in complicated installation space situations, and which can be easily repaired, so that a sustainable product is provided.

In the same way, there may be a need to provide a plug-in connector having the properties described above.

This need can be met by certain features of the present invention. Advantageous embodiments of the present invention are disclosed herein.

According to a first aspect of the present invention, a plug-in connector arrangement is provided, in particular for high-current applications and/or high-voltage applications, in particular for automotive applications, in particular for electric vehicles (which can also include, e.g., fully or partially electrically powered aircraft, ships, boats, e-bikes, motorcycles).

According to an example embodiment of the present invention, the plug-in connector arrangement comprises a plug-in connector and a mating plug-in connector for plugging together with the plug-in connector. The plug-in connector comprises a lamella cage having a base element and having a plurality of contact lamellae. The contact lamellae are connected to the base element in a rear section; they protrude from the base element in the direction of the mating plug-in connector. The contact lamellae comprise a front section which faces the mating plug-in connector and which comprises a cantilevered end or by which the contact lamellae are connected to a head element of the lamella cage (in this alternative, the contact lamellae are connected to the head element by means of the front section). The contact lamellae comprise a contact-making section arranged between the rear section and the front section. The lamella cage comprises a coupling section. The plug-in connector comprises a contact chamber with an outer wall. The lamella cage is arranged in the contact chamber. The contact-making sections are pre-bent in the direction of the outer wall in relation to the rear section and the front section, in particular, e.g., in the force-free state. The mating plug-in connector comprises a contact element having a bottom side facing the lamella cage. The contact element and/or the mating plug-in connector can, in particular when plugged together with the connector, be displaced between a first position and a second position, in particular along an insertion direction. At least up to the first position, the contact element and/or the mating plug-in connector can be displaced along the insertion direction with a force of less than 5 N, in particular in a force-free manner. In the second position, the contact element mechanically contacts the coupling section of the lamella cage in such a way that the contact-making sections of the contact lamellae are displaced toward the outer wall, in particular along a radial direction, and the contact-making sections as a result electrically contact a contact section of the outer wall.

As a result, according to an example embodiment of the present invention, it is advantageously effected that the lamella cage can be mounted particularly easily and reliably in or on the plug-in connector and can also be removed again. It can be inserted or pushed, e.g., into the contact chamber. As a result, it is automatically arranged in the correct position in the plug-in connector. Furthermore, as a result a particularly large electrical transition area from the lamella cage to the plug-in connector can be advantageously formed by means of the defined contacts of the majority of the contact lamellae on the contact section of the outer wall, which reduces contact resistance. This is also possible if, in the first position or directly after the assembly of the lamella cage, it is not pressed particularly tightly against the contact chamber or even if the lamella cage is arranged loosely in the contact chamber. Furthermore, e.g., an additional electrical conduction path can be formed at least in the second position in that a bottom of the contact chamber is electrically contacted with the base element if the lamella cage is pressed against the bottom of the contact chamber by the force of the contact element. In this way, it is advantageously possible to dispense with a complex press-in assembly, e.g. into a printed circuit board, or with soldering or welding of the lamella cage, e.g. onto a carrier substrate or an electrical component, or with a complex press-in assembly or the like into a contact chamber.

The electrical contacting between the lamella cage and the contact element (and thus between the plug-in connector and the mating plug-in connector) can be achieved, e.g., by the mechanical contacting between the coupling element and the contact element. This can be carried out, e.g., by applying an axial force to the coupling region, e.g., through the bottom side of the contact element. In this way, a high contact normal force between the contact element and the coupling region or coupling section can advantageously be achieved, without the contact element and the coupling region or coupling section having to cover a longer axial friction distance relative to each other, which could otherwise damage the surfaces of the contact partners as a result.

According to an example embodiment of the present invention, it can be provided, e.g., that the outer wall of the contact chamber, in the force-free state of the lamella cage, rests loosely on the contact-making sections of the contact lamellae or is preferably spaced apart from the base element by a (radial) gap, e.g., by a gap of at most 500 μm, preferably of at most 200 μm and particularly preferably of at most 100 μm. In this way, the lamella cage can be easily inserted into the contact chamber, ideally in a force-free manner. At the same time, however, it is positioned very precisely with respect to the radial direction, which ensures a simple and reliable joining process with the mating plug-in connector and also leads to radial contacting of the contact-making sections with the contact section, even with a small axial compression path, in particular with a high contact normal force. This results in a high possible path-force ratio.

Furthermore, according to an example embodiment of the present invention, it is advantageous that the joining or plugging together of the plug-in connector and mating plug-in connector can be effected in a largely force-free manner or with a very low insertion force and the actual application of the contact element of the mating plug-in connector with the contact normal force is only carried out at the end of the plugging process. In contrast to conventional lamella cages, in which the insertion process of a male mating contact element of the mating plug-in connector must already widen the contact lamellae radially outward in the region of the contact lamellae (the so-called “snap peak” in the insertion force) and the frictional force between the contact lamellae and the contact element must also be overcome as it travels further, according to the present invention an increased force—which is necessary so that the contact lamellae are displaced radially outward or radially toward the outer wall (in particular by an axial compression) and can thus apply the contact normal force to the contact element—is only to be applied at the end of the insertion process or the joining process. This advantageously simplifies the assembly process, also advantageously allows larger manufacturing tolerances, since tilting due to the insertion forces is prevented and advantageously also allows correction of the assembly of the plug-in connector and mating plug-in connector during the assembly process (at least up to the first position). Furthermore, the joining and/or plugging process in a manufacturing line can also be advantageously distributed across different, spatially separated machines or workstations: in a first step, the plug-in connectors and mating plug-in connectors are, e.g., simply plugged or joined together until the first position is reached. This is done substantially in a force-free manner or with very little insertion force. In this first position, the contact element of the mating plug-in connector is advantageously already in loose mechanical contact with the coupling section or is only slightly spaced apart from it (along the insertion direction), e.g., at most 200 μm or at most 100 μm). In a second step (which can also be carried out at another workstation or by other machines or technicians), the application of the contact normal force can then be carried out, and thus the formation of the desired electrical (and also mechanical) connection can be carried out. In this way, pre-assembly is possible. It may also be possible, e.g., that the pre-assembly process (reaching the first position) is secured, e.g., mechanically, e.g., by a type of primary locking, so that the pre-assembled plug-in connector arrangement can be transported to another location without problems and without loss.

In addition, as a result, it is advantageously prevented that the surfaces of a male mating contact element and contact lamellae are damaged or destroyed during the joining process along a longer path (e.g., from the beginning of the overlap of the contact lamella contact point and the contacting part of the contact element up to a contact section of the contacting part), as is the case in the related art. This is because, due to the axial force exerted, the lamellae are displaced primarily radially when the lamella cage is compressed and not, or only very slightly, in the axial direction. Thus, there is hardly any frictional movement between two surfaces along the axial direction. As a result, a repeated plugging together and unplugging of the plug-in connector and mating plug-in connector (e.g., for repairs, maintenance, etc.) is allowed, as a result of which the sustainability of the plug-in connector arrangement and the associated components is advantageously improved.

Furthermore, according to an example embodiment of the present invention, the number of contact lamellae can be increased compared to conventional plug-in connector arrangements (with a male mating contact element which is inserted into the interior of a lamella cage or a socket contact and which has to push the contact lamellae present there apart during the insertion path), and/or the applied normal force of the contact lamellae in the final plugging position can be increased. Alternatively or additionally, a material can be used for the contact lamellae which comprises a higher spring constant or a higher modulus of elasticity. As a result, an improved current carrying capacity can be achieved over the lifetime, the thermal load on the contact partners in the contact region can be advantageously reduced (lower contact resistance) and the plug-in connector arrangement can as a result exhibit increased robustness, e.g., against alternating thermal loads, vibrations and/or manufacturing tolerances. Only at the end of the plugging process—on the (particularly short) path from the first position to the second position—an increased axial force must be applied in order to apply a radially acting contact normal force (between contact lamellae and outer wall). This axial force also influences, e.g., the contact normal force between the lamella cage and the contact element. Due to the small axial path with increased force expenditure, e.g., an actuating element can be arranged on the plug-in connector and/or on the mating plug-in connector which, despite a possibly limited operating path, comprises a particularly high force transmission (e.g., more than 10:1 or more than 50:1, or more than 100:1). In cases where there is little installation space and little space for the movement of such an actuating element, the present invention can ensure that a significant force transmission is possible using simple means. Such an operating element or actuating element—which can be provided optionally, but is not absolutely necessary and thus not essential—can be designed, e.g., as a lever or a slider. Such an actuating element can be arranged, e.g., on a plug-in connector housing or on a mating plug-in connector housing. It can, e.g., comprise a link structure which interacts with a complementary pin or bolt on the mating element (if the actuating element is arranged, e.g., on the plug-in connector or connector housing, then the bolt or pin can be arranged on the mating plug-in connector or mating plug-in connector housing).

Compared to a purely axial contacting, in which the lamella cage would only be clamped axially between a base of the contact chamber and the contact element, the number of contact points between lamella cage and contact chamber is advantageously increased. As a result, the current carrying capacity is increased, the electrical contact resistance is reduced, the redundancy of the contact points is increased, the thermal load on the contact point is reduced and also robustness with respect to manufacturing tolerances and to vibrations and/or shaking loads is further improved. This is because the contacts between the base element and the bottom of the contact chamber are formed along the axial direction and are thus orthogonal to the contact points between the contact lamellae and the outer wall, which preferably act or are formed in the radial direction.

According to an example embodiment of the present invention, the insertion direction can, e.g., be given as the direction along which the mating plug-in connector is plugged together with the plug-in connector. It can preferably be defined, e.g., as the direction along which the contact element is displaced relative to the lamella cage in order to effect the contacting. The insertion direction can also be referred to as the axial direction.

The radial direction runs, e.g., perpendicular to the insertion direction. One circumferential direction runs around, e.g., the insertion direction.

The contact lamellae can, e.g., be pre-bent with their contact-making sections in the radial direction toward the outer wall or in the direction of the outer wall.

According to an example embodiment of the present invention, in the second position, the contact-making sections of the contact lamellae in cooperation with the contact section of the outer wall can clamp the lamella cage, e.g., within the outer wall. As a result, it is advantageously effected that, e.g., a lamella cage initially loosely inserted into the contact chamber comprises a secure and permanent contacting with the contact chamber in the final contacted state (second position). If the contact element is displaced back to the first position or even further, the lamella cage can again sit or be arranged loosely in the contact chamber, e.g. due to an elastically reversible design of the contact lamellae, and can thus be easily replaced, e.g. for repair or maintenance.

The coupling of the coupling section can be carried out, e.g., by a bottom side of the contact element that faces the coupling section. This bottom side can, e.g., be designed to be substantially planar, even or flat. The contacting or the mechanical force effect of the contact element on the coupling section can, for example, be carried out substantially along the axial direction or the insertion direction.

The coupling section can be formed, e.g., by the front section or by the head element.

The bulging of the contact-making section(s) can be understood to mean that, viewed in the radial direction in the force-free state, the contact-making section is less spaced from the outer wall (or is closer to the outer wall) than the front section and/or the rear section. This can advantageously have the effect that in a simple manner—without further material influence such as, e.g., targeted weakening or strengthening of the material or thermal, chemical or other treatments—an axial compression of the lamella cage leads to a displacement of the contact lamellae in the contacting region even closer to the outer wall and finally for contacting. In other words, an axial force then leads to an even further bulging toward the outer wall. As a result the contact lamellae comprise a well-defined preferred direction for displacement in the event of axial force or axial compression.

The contact element can, e.g., cover the coupling section in the radial direction or protrude beyond the coupling section, e.g. by at least 500 μm, particularly preferably by at least 1 mm. It can completely cover, e.g., the coupling section. As a result, a particularly reliable mechanical contacting when being displaced from the first to the second position and when in the second position is advantageously effected. As a result, positioning tolerances in the radial direction advantageously are also unproblematic.

In contrast to conventional contact elements which are inserted into the interior of the lamella cage as male contact elements, e.g., the contact element may not comprise a contact part protruding from a head section of the contact element. Rather, according to an example embodiment of the present invention, the bottom side can be designed, e.g., without such a contact part. The contact element can, e.g., be designed to be substantially flat on the bottom side in a side view. However, in other embodiments it can also comprise a centering part which protrudes from the bottom side like a male contact part. Such a centering part can serve, e.g., to guide the contact element into the correct (radial) position relative to the lamella cage when plugging them together. It can be threaded, e.g., into the interior of the lamella cage and thus center the contact element in the radial direction. Furthermore, as a result the guidance of the contact element can be simplified (compared to a contact element with a flat or planar bottom side), so that tilting that occurs during plugging together, in particular when being displaced from the first position to the second position, is prevented. Such a centering part can, e.g., be formed integrally with the head section of the contact element. However, it can also be made of a different material, e.g., an insulating material, and/or be subsequently coupled or connected to the head section to form a unit that is then present.

Such a centering part can, e.g., protrude at least 2 mm from the contact element or a head section of the contact element, preferably at least 5 mm and particularly preferably at least 10 mm.

According to an example embodiment of the present invention, the lamella cage can, e.g., be designed so that the contact element with such a centering part can be inserted into an interior of the lamella cage.

The base element and/or an optionally present head element of the lamella cage can, for example, also be referred to as a collar or, e.g., be designed as a collar to which the contact lamellae are attached. The base element and contact lamellae or the head element and contact lamellae can be made, e.g., in one piece, e.g., from a single piece of sheet metal. They can be designed, e.g., as stamped and bent parts. The contact lamellae can, e.g., be designed to contact the contact section, in particular to contact it electrically. If a head element is provided, the head element can be designed or serve or act as, e.g., a coupling section. It can then, e.g., protrude furthest in the direction of the contact element or form a type of end face of the lamella cage with respect to the contact element. In this configuration, the head element can even out the force distribution on the individual contact lamellae even if the force acting through the contact element is uneven (e.g., if the contact element is tilted). This also applies in the case of an established contacting, where, e.g., vibrations lead to a changing force distribution along the head section. As a result, a particularly secure and uniform contacting of the contact section of the outer wall with a well-defined contact normal force is effected.

According to an example embodiment of the present invention, the contact lamellae can, e.g., comprise a cantilevered or free end in the front section or can be designed to be cantilevered in the front section. It can be provided, e.g., that the contact lamellae in the front section are not connected to each other. Such a free end can, e.g., point directly in the direction of the mating plug-in connector and thus represent a type of end face of the contact lamella in the direction of the contact element. However, there may also be embodiments in which the contact lamellae are bent at or with their free end and point, e.g., in a radial direction (radially inward or radially outward) or even in the direction of the base element. In such a case, a part of the front section forms the end face that protrudes furthest from the base element in the direction of the contact element. This end face or the front section or the free ends can represent the coupling section in this configuration. This can advantageously result in a particularly high number of contact points between the lamella cage and the contact element.

The displacement between the first position and the second position can be carried out, e.g., along the insertion direction. The first position can be, e.g., an intermediate plugging position, in which a large part (e.g., more than 70%, preferably more than 90%) of the plug-in path between the connector and the mating plug-in connector has already been covered. The second position can be, e.g., an final plugging position.

In the first position, e.g., a gap can be formed between the contact-making sections and the outer wall (with simultaneous overlap of the contact-making sections and the outer wall). This gap can allow for, e.g., radial play between the contact chamber or outer wall and the contact lamellae or lamella cage. In this way, the lamella cage can be easily installed or removed.

In the second position, the contact lamellae, in cooperation with the outer wall, can clamp the lamella cage, e.g., within the outer wall. The clamping can be formed, e.g., along the radial direction. The term “clamping” here means that the lamella cage is securely held or clamped in the contact chamber by the contact lamellae, assuming that the contact element remains unchanged on the coupling section in the second position. The lamella cage is thus clamped or fixed within the outer wall or inside the contact chamber when viewed along the radial direction. In other words: in the second position, the lamella cage comprises an oversized dimension with respect to the contact chamber with respect to the space delimited by the outer wall (in the case of only two contact lamellae which would be approximately opposite each other, the oversized dimension could be formed, e.g., with respect to the distance between the contact lamellae).

It can be provided, e.g., that the contact lamellae and the outer wall enclose a contact space between them.

In other words: The contact space can be formed, e.g., radially outside the contact lamellae. It can be, e.g., part of an outer space of the lamella cage.

According to an example embodiment of the present invention, the contact chamber can, e.g., comprise an oversized dimension (in particular along the radial direction) with respect to the lamella cage when not fully plugged together (i.e., during the insertion or joining process up to the first position). In the fully plugged-together state, in particular in the second position, the lamella cage can, e.g., comprise an oversized dimension (in particular along the radial direction) compared to the contact chamber.

The term “force-free” is to be understood in such a way that the joining or plugging together of the plug-in connector and mating plug-in connector, at least up to the first position, requires only an insignificant amount of force or an insignificant amount of mating force, and in particular no snap peak for pushing apart contact lamellae or a friction force between the contact partners has to be overcome. In particular in the case of power contacts for high-current or high-voltage applications, a joining force or mating force of less than 10 N, preferably less than 5 N and particularly preferably less than 3 N can be considered “force-free.”

The contact lamellae can be, e.g., designed to be elastically reversible. This means that when the contact element returns from the second position to the first position, the contact lamellae are displaced back to their original position (i.e., they are displaced radially away from the outer wall). As a result, an unplugging or disconnection processes can be carried out without greater unplugging force and/or without damaging the surfaces of the contact partners (outer wall to contact lamellae, but also, e.g., coupling section to contact element). In addition, a new plugging or joining process is then possible, at least up to the first position, (almost) in a force-free manner.

It can be provided—in particular in the case of contact lamellae which are arranged opposite each other, e.g., that the contact element mechanically contacts the coupling section in such a way that the contact lamellae, in particular their contact-making sections, are displaced radially outward on the path of the mating plug-in connector or in particular of the contact element from the first position to the second position, and as a result the contact-making sections electrically contact the contact section of the outer wall. In the second position, the contact lamellae or their contact-making sections are then displaced radially outward or radially toward the outer wall and contact the contact section.

On the path from the first position to the second position and in the second position, the contact element can, e.g., be in axial contact with the coupling section of the lamella cage and as a result exert an axial force on the lamella cage and in particular on the contact lamellae, which leads to the at least partial displacement of the contact lamellae in the radial direction toward the outer wall. In the second position, the contact element can be pressed onto the coupling section, in particular along the axial direction.

According to an example embodiment of the present invention, the contact element can, e.g., be designed in one piece. For example, in the case where a contact element is provided with a head section and a centering element or centering part protruding therefrom in the direction of the lamella cage, the centering part and the head section cannot be designed to be releasable from each other without causing damage. It can be provided, e.g., that the head section and the centering part are rigidly connected to each other, in particular cannot be displaced relative to each other. Alternatively, it can be provided that the head section can be displaced relative to the centering part, e.g., along the axis of the centering part. For example, the centering part can be movable through an opening in the head section. The centering part and the head section can be made, e.g., of an electrically conductive material, e.g., the same material. In an alternative embodiment, the head section and/or a bottom side of the head section can be formed, e.g., from a different material than the centering part, e.g. the centering part can be formed from an insulating material, wherein the centering part is designed or configured or serves only for the radial positioning of the contact element relative to the lamella cage.

The contact element or the head section or the bottom side can, e.g., be designed to be electrically conductive, in particular in those regions which are mechanically in contact with the coupling section in the second position.

An optionally present centering part can comprise, e.g., a diameter between 2 mm and 30 mm, preferably between 4 mm and 20 mm.

A single contact lamella can, e.g., comprise a thickness in the range of 200 μm (200 micrometers) to 3 mm, preferably between 400 μm and 2 mm. A slat width or width of a slat can, e.g., be greater than the thickness of the contact slat.

According to an example embodiment of the present invention, it can be provided, e.g., that the diameter of the outer wall of the contact chamber is at least 20 μm larger than a diameter of the lamella cage, preferably at least 50 μm.

The term “comprise” is used synonymously with the term “have”, unless otherwise stated.

In a further development of the present invention, in the second position the contact lamellae contact the contact section with a contact normal force in the radial direction of at least 1 N, preferably of at least 5 N. For example, the contact normal force of the contact lamellae, in particular of each contact lamella or the majority of contact lamellae, is in a range between 5 N and 50 N or even between 5 N and 200 N. As a result, a particularly safe and reliable contacting, which has a low contact resistance over its service life, even in the event of vibrations, alternating thermal loads or other operating conditions, is advantageously effected. As a result, heating at the transition between the contact partners can advantageously be kept to a minimum, even at high currents of, e.g., more than 50 A or even more than 100 A. Furthermore, as a result, the installation space, weight and material usage in the contact zone can be advantageously reduced, in particular at the lamella cage, since reliable contacting by means of high contact normal force allows a small number of contact points. Furthermore, as a result the service life of the plug-in connector arrangement is advantageously increased.

In a further development of the present invention, the base element and/or the head element of the lamella cage is designed to be circumferentially closed. As a result, it is advantageously effected that the lamella cage is designed to be particularly stable and in the second position the contact lamellae cannot spread the base element apart. This advantageously results in a particularly reliable and permanent application of the contact normal force. A closed head element advantageously achieves stabilization in the same way. It also prevents the head element from spreading open when mechanically contacted by the contact element, as a result causing partial or complete loss of contact with the contact part.

According to an example embodiment of the present invention, it can be provided, e.g., that the base element and/or the head element or the collar (the further collar) or the collar region (or the further collar region) of the lamella cage is designed to be annularly closed.

The base region and/or the head element can comprise a circular or elliptical cross section, e.g., in the force-free state (i.e., before mounting the mating plug-in connector). In principle, however, a polygonal, e.g., triangular, square, pentagonal, hexagonal, heptagonal, octagonal cross section of the base element and/or the head element is also possible. Even more than eight corners are possible.

The circumferentially closed shape can be achieved, e.g., by rolling up an originally flat stamped and bent part, e.g., made of a metal sheet. In order to keep the base region and/or the head element closed, a material-bonded connection (e.g., by a welding process or an adhesive process or a soldering process) can be provided. However, a form-fitting connection can also be provided; e.g., at one end of the base region and/or the head element at least one type of eyelet or a type of recess with a neck region with a flat or narrow neck can be formed and at the other end of the base region and/or the head element at least one type of pin with a shape complementary to the eyelet or the recess (tongue-and-groove principle). After the stamped and bent part has been rolled up, the at least one pin can then be inserted into the complementary at least one associated eyelet or recess, so that the base element and/or the head element cannot unroll again. A form-fitting connection makes it possible to achieve a particularly simple and cost-effective assembly and temperature-stable connection.

In a further development of the present invention, the first position and the second position are spaced apart along the insertion direction by a maximum of 5 mm, preferably by a maximum of 2 mm and particularly preferably by a maximum of 1 mm. As a result, it is advantageously effected that the contact partners (contact lamellae, in particular their contact-making sections and outer wall, in particular their contact section; if applicable also coupling section and contact element or its bottom side) can only rub against each other along a very short, in particular axial, distance, and as a result damage to the surfaces is prevented or limited to a very short path range. Furthermore, as a result a plug-in connector arrangement that requires only an extremely small installation space along the insertion direction can be advantageously provided. Finally, a particularly high normal force can advantageously be applied in this way if, e.g., an actuating element is provided for reducing the operating force. For example, if the distance between the first position and the second position is 1 mm and the path of an optional actuating element, such as, e.g., a slide element or a rotatably mounted lever element, is 100 mm, then a force transmission of 100:1 can be achieved. The entire path of the actuating element and thus the entire force transmission can be used to apply the contact normal force as a result. There is no need to waste part of the actuation path for part of the joining path. Furthermore, e.g., the force transmission can advantageously be designed to be highly uniform along the actuation path, e.g., by means of a substantially linear link profile having a uniform gradient in the actuating element. This is because an optional actuating element only needs to be used for the distance from the first position to the second position and not for the entire joining path. Alternatively, the actuation path can be reduced with the same force transmission, as a result of which installation space or free space can be saved for the actuation of the actuating element.

In a further development of the present invention, in the first position the radial play between the contact-making section and the outer wall is in a range between 5 μm (5 micrometers) and 200 μm (200 micrometers) or in a range between 20 μm and 100 μm. As a result, it is advantageously effected that a high contact normal force can be formed even with a short distance between the first position and the second position. Furthermore, as a result a high force transmission can be achieved, since only a very small radial path has to be covered for the contacting or only a very small gap has to be closed. For example, if an axial path of 1 mm is available between the first and second positions and the gap or radial play is uniformly 100 μm all around, a force transmission of 10:1 can already be achieved. At the same time, such a small radial play already advantageously allows the insertion or joining process to be carried out in an almost force-free manner, at least up to the first position. Such a small play also allows a particularly compact design of the lamella cage and/or the plug-in connector in the radial direction.

In a further development of the present invention, a groove with an inner groove wall, a groove bottom and an outer groove wall is introduced into the bottom side of the contact element for receiving the coupling section.

As a result, it is advantageously effected that the coupling section or the head element or the contact lamellae (in particular with their front section or the part of the contact lamella that protrudes furthest from the base element in the direction of the contact element (with their end face)) can be received or arranged in the groove, and in particular are arranged or received in the groove in the second position. This capture of the coupling element or the head element or the contact lamellae can, e.g., already be carried out in the first position of the contact element. As a result, it is advantageously effected in turn that during the (further) displacement of the contact element from the first position to the second position, the coupling section or the head element or the front sections of the contact lamellae are always in a defined position and the pressing process of the contact lamellae in the radial direction against the outer wall is carried out in a particularly defined and reliable manner. At the same time, tilting or jamming of the contact element or its head part when moving from the first position to the second position is prevented, which could be caused, e.g., without the groove by individual contact lamellae whose front section could be radially misplaced, e.g. due to manufacturing tolerances, etc. The groove thus catches the front sections and then allows the correct establishment of the plug-in connection in the contact section when displaced to the second position.

Furthermore, due to such a groove, the contact surface between the coupling section and the contact element and thus between the lamella cage and the contact element is advantageously increased, in particular compared to an embodiment in which contacting is only carried out on a flat bottom side. This is because by displacing the contact element into the second position, the part of the coupling section or the head element or the contact lamellae caught in the groove can ultimately only expand in the radial direction in the groove, since the axial space available to the contact lamella is shortened. This expansion in the groove leads to a larger filling of the groove with parts or with material of the contact lamella and thus to a larger contact surface (the groove comprises an inner groove wall, a groove bottom and an outer groove wall). Furthermore, by filling the groove more with material of the contact lamella, the force of the contact lamella in the groove on the groove walls and the groove floor is also increased, which increases the contact normal force of the coupling section or the head element or the contact lamellae to the boundary surfaces of the groove (groove walls and groove floor). As a result, additional contact paths are advantageously effected in the groove, which increases the redundancy of the contact points, reduces contact resistance and advantageously increases the reliability and service life of the plug-in connector arrangement and in particular of the contact point. Alternatively or additionally, the groove can clamp the coupling section or the head element or the contact lamellae in the radial direction (between the groove inner wall and the groove outer wall) and thus create lateral contact surfaces. This can be achieved in particular if the groove is designed to be narrow enough, at least in sections, so that, e.g., the coupling section or head element or contact lamellae comprise an oversized dimension with respect to a distance between the groove inner wall and the groove outer wall.

According to an example embodiment of the present invention, the groove can, e.g., be designed to be circumferential. It can, e.g., be designed to be closed, in particular closed all around. It can comprise, e.g., the same cross section throughout.

If a centering part is present, the groove can be arranged, e.g., between the centering part and an edge of the bottom side. It can, e.g., rotate about the centering part in the circumferential direction.

Thus, as a result, the number of contact points between the lamella cage and the contact element increases, contact resistance is reduced and robustness against vibrations, thermal loads and manufacturing tolerances is improved.

According to an example embodiment of the present invention, it can be provided, e.g., that the coupling section or the head element or the contact lamellae contact the groove, in particular on at least two sides. This advantageously results in a further increase in the contact surface or the contact points between the lamella cage and the contact element. As a result, robustness against adverse operating conditions is increased and contact resistance is reduced. As already described above, the groove comprises three surfaces or sides: an inner groove wall or groove inner side (which, e.g., in the case of a groove running in the circumferential direction in the contact element, encloses an inner region and/or, e.g., runs around an optionally provided centering part), a groove outer wall or groove outer side (which, e.g., is formed radially outside the groove inner wall and, e.g., runs closer to an edge of the contact element or the head section thereof or which is closer to the outer wall of the contact chamber than the groove inner side) and a groove bottom or a bottom side. The groove bottom can, e.g., extend transversely to the insertion direction.

According to an example embodiment of the present invention, it can be provided, e.g., that the surfaces or sides of the groove contacted by the front section are rotated at least 30° relative to each other. Thus, in the second position, e.g., the groove bottom and the groove inner wall can be contacted by the coupling section or the head element or the contact lamellae or their front section, or the groove bottom and the groove outer wall or all three walls can be contacted by the coupling section or head element or contact lamellae.

In a further development of the present invention, in the second position the mechanical contacting of the coupling section is carried out with the groove bottom.

In other words: in the second position the contact element with the groove bottom mechanically contacts the coupling section in such a way that the contact-making sections of the contact lamellae are displaced along the radial direction toward the outer wall and as a result electrically contact a contact section of the outer wall and in particular clamp the lamella cage within the outer wall.

In other words: the groove bottom exerts a force acting substantially in the axial direction on the coupling section or on the end face thereof. As a result, the contact lamellae are compressed in the axial direction and deviate radially in the contact-making section in the direction of the outer wall. As a result, the contact section of the outer wall is mechanically and electrically contacted by the contact-making sections of the contact lamellae and a defined contact normal force is applied by the contact lamellae to an inner side of the outer wall.

As a result, a particularly defined position of the mechanical contacting of the coupling section is advantageously effected.

Furthermore, as a result an axial contacting between the lamella cage and the contact element that is particularly robust against vibrations, thermal expansion, manufacturing tolerances, etc., which act in the radial direction, is advantageously effected.

In a further development of the present invention, an groove inner wall, in particular facing away from an outer edge of the bottom side, runs obliquely outward toward a groove bottom.

In other words: the groove comprises—if viewed from the bottom side—a funnel-shaped slope on the groover inner side further away from the edge or further away from the outer wall of the contact chamber.

As a result, it is advantageously effected that the contact lamellae (in particular with their contact-making section) are not displaced in a radial direction solely due to an axial force of the contact element acting on the front section. Rather, the slope can create a type of guide rail by which the coupling section is moved or displaced in a targeted radial direction toward the outer wall. In this way, the displacement can be influenced in a targeted or more targeted manner. Furthermore, the shape of the slope can advantageously form a type of path-force curve, by means of which the translation of the axial path of the contact element into a radial path of the contact lamellae can be adjusted when the contact element is displaced from the first position to the second position. By adjusting the slope, the application of the normal force can be advantageously adapted to the specified installation space situation and to the available path from the first position to the second position.

In particular, the groove can run obliquely on the groove inner wall in such a way that a type of (half-) funnel shape can be seen when looking into the groove.

A first angle of the groove inner wall with respect to the insertion direction can be, e.g., in a range between 2° and 45° or in a range between 3° and 15°.

In a further development of the present invention, the groove comprises a funnel shape in cross section.

In other words: the groove inner wall and the groove outer wall both run obliquely and taper into the contact element.

According to an example embodiment of the present invention, it can be provided, e.g., that the groove comprises the shape of an inverted “V” or the shape of a “Y,” wherein the more open side of this shape faces the coupling section.

As a result, it is advantageously effected that the coupling section or the head element or the contact lamellae can be securely threaded into the groove even with positioning and/or manufacturing tolerances. As a result, manufacturing reliability when plugging together the plug-in connector and mating plug-in connector is advantageously increased.

Furthermore, as a result a larger contact surface and a higher number of contact points between the lamella cage and the contact element are advantageously effected. If, e.g., at the narrow point of the funnel the coupling section or the head element or the contact lamellae comprises an oversized dimension with respect to the funnel width at this point, the coupling section or the head element or the contact lamellae are clamped laterally and thus contacted. Here as well, the funnel shape offers an advantage in terms of manufacturing tolerances. This is because if, e.g., the coupling section is too wide, insertion into the groove will not be blocked or will lead to damage to the groove and/or coupling section. Rather, the coupling section is inserted into the funnel-shaped groove until it reaches an oversized dimension with respect to the funnel shape and is clamped. A further axial displacement of the contact element is converted into a further compression of the contact lamellae in the contacting region and then increases the normal force there.

In this way, particularly high manufacturing reliability along with a particularly safe and reliable contacting between the lamella cage and the contact element are effected.

In a further development of the present invention, in the second position the coupling section is clamped between the groove inner wall and the groove outer wall, so that the coupling section electrically contacts both the groove inner wall and the groove outer wall.

As a result, a particularly large contact surface between the lamella cage and the contact element is advantageously effected. Another advantage of this method is that the contacting is particularly robust against, e.g., mechanical or thermal influences and/or manufacturing tolerances in the axial and radial directions.

According to a further aspect of the present invention, a plug-in connector, in particular for high-current applications and/or high-voltage applications, is provided.

The plug-in connector is suitable or configured for plugging together with a mating plug-in connector comprising a contact element. The plug-in connector comprises a lamella cage having a base element and having a plurality of contact lamellae. The contact lamellae are connected to the base element in a rear section; they protrude from the base element in the direction of the mating plug-in connector. The contact lamellae comprise a front section which faces the mating plug-in connector and which comprises a cantilevered end or by which the contact lamellae are connected to a head element of the lamella cage. The contact lamellae comprise a contact-making section arranged between the rear section and the front section. The lamella cage comprises a coupling section, wherein the coupling section can be formed, merely by way of example, by the front section or by the head element. The plug-in connector comprises a contact chamber with an outer wall. The lamella cage is arranged in the contact chamber. The contact-making sections are pre-bent (e.g., radially) in the direction of the outer wall in relation to the rear section and the front section, in particular, e.g., in the force-free state.

The lamella cage is designed such that when a force is applied along an insertion direction to the coupling section (e.g., via a contact element of the mating plug-in connector) or by a displacement of the coupling section along the insertion direction, which corresponds e.g., to a displacement of the contact element and/or the mating plug-in connector from the first position to the second position, the contact-making sections of the contact lamellae are displaced along a radial direction toward the outer wall and the contact-making sections as a result electrically contact a contact section of the outer wall and in particular clamp the lamella cage within the outer wall.

As a result, the same advantages as described above for the plug-in connector arrangement of the present invention arise.

### BRIEF DESCRIPTION OF THE DRAWINGS

Further features and advantages of the present invention will become apparent to a person skilled in the art from the following description of exemplary embodiments with reference to the figures, which, however, are not to be interpreted as limiting the present invention.

FIG. 1 is a schematic perspective view of a plug-in connector arrangement in a non-contacted state, according to an example embodiment of the present invention.

FIGS. 2A to 2C are perspective schematic views of two different lamella cages of a plug-in connector (FIGS. 2A and 2B) along with a top view of a stamped sheet (FIG. 2C) as the initial state for a lamella cage, according to an example embodiment of the present invention.

FIGS. 3A and 3B are schematic cross sections through a plug-in connector arrangement with the mating plug-in connector in a first position (FIG. 3A) and in a second position (FIG. 3B), according to an example embodiment of the present invention.

FIGS. 4A and 4B are schematic cross sections through two further plug-in connector arrangements with the mating plug-in connector in the second position, according to an example embodiment of the present invention.

FIGS. 5A and 5B are schematic cross sections through a further plug-in connector arrangement with the mating plug-in connector in the first position (FIG. 5A) and in the second position (FIG. 5B), according to an example embodiment of the present invention.

### DETAILED DESCRIPTION OF EXAMPLE EMBODIMENTS

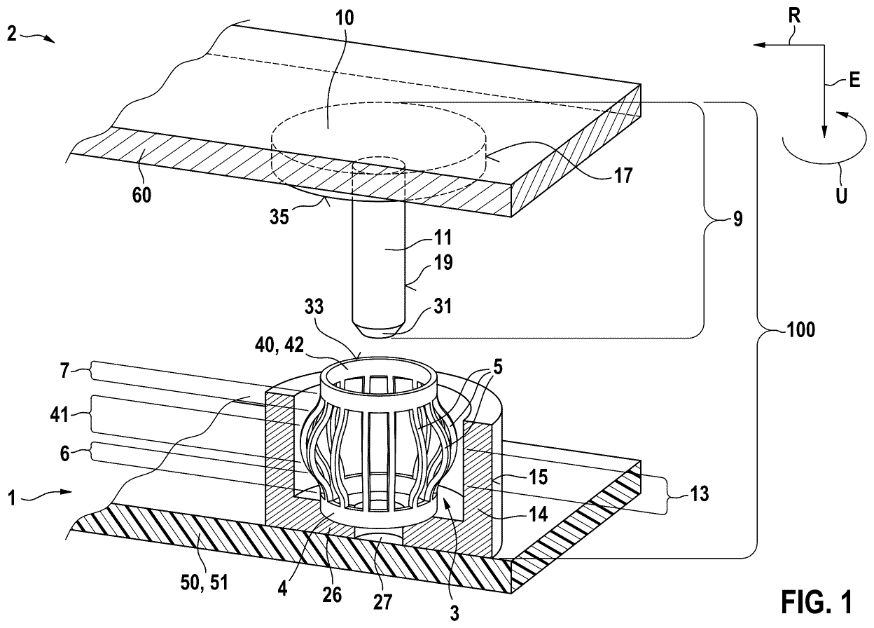

FIG. 1 shows a schematic perspective view of a plug-in connector arrangement 100 in a non-contacted state, e.g., in a pre-plugged position. For reasons of clarity, neither an actuating element (such as, e.g., a lever element or a slider element) for reducing the operating force when plugged together, nor a plug-in connector housing nor a mating plug-in connector housing are shown here.

Such elements are conventional and do not represent essential elements for the implementation of the present invention.

The plug-in connector arrangement 100 is configured here merely by way of example for high-current applications (e.g., for transmitting at least 10 A, preferably at least 50 A, and particularly preferably at least 100 A) and/or high-voltage applications (e.g., for at least 100 V, preferably at least 200 V, and particularly preferably at least 500 V).

The plug-in connector arrangement 100 comprises a plug-in connector 1 along with a mating plug-in connector 2 for plugging together, here e.g., in particular along an insertion direction E, with the plug-in connector 1, wherein a radial direction R runs perpendicular to the insertion direction E and wherein a circumferential direction U runs around the insertion direction E. The insertion direction E can also be referred to as the axial direction. In other cases, it can also be defined as the displacement direction of a contact element 9 described below with respect to a lamella cage 3 described below during the contacting process.

The plug-in connector 1 comprises a lamella cage 3 having a base element 4 and having a plurality of contact lamellae 5. The contact lamellae 5 are connected to the base element 4 in a rear section 6. They protrude from the base element 4 in the direction of the mating plug-in connector 2 and they comprise a front section 7 which faces the mating plug-in connector 2 and by means of which—here by way of example—the contact lamellae 5 are connected to a head element 40 of the lamella cage. In other embodiments, the contact lamellae 5 can, by way of example, comprise a cantilevered end 8 in the front section 6. The contact lamellae 5 further comprise a contact-making section 41 which is arranged between the rear section 6 and the front section 7.

Furthermore, the lamella cage 3 comprises a coupling section 42. This is formed here by the head element 40 merely by way of example. In other embodiments, it can be formed, e.g., by the front section 7.

The plug-in connector 1 further comprises a contact chamber 14 with an outer wall 15, wherein the lamella cage 3 is arranged in the contact chamber 14. The contact-making sections 41 are, in particular in relation to the rear section 6 and the front section 7, (here by way of example: radially) pre-bent in the direction of the outer wall 15.

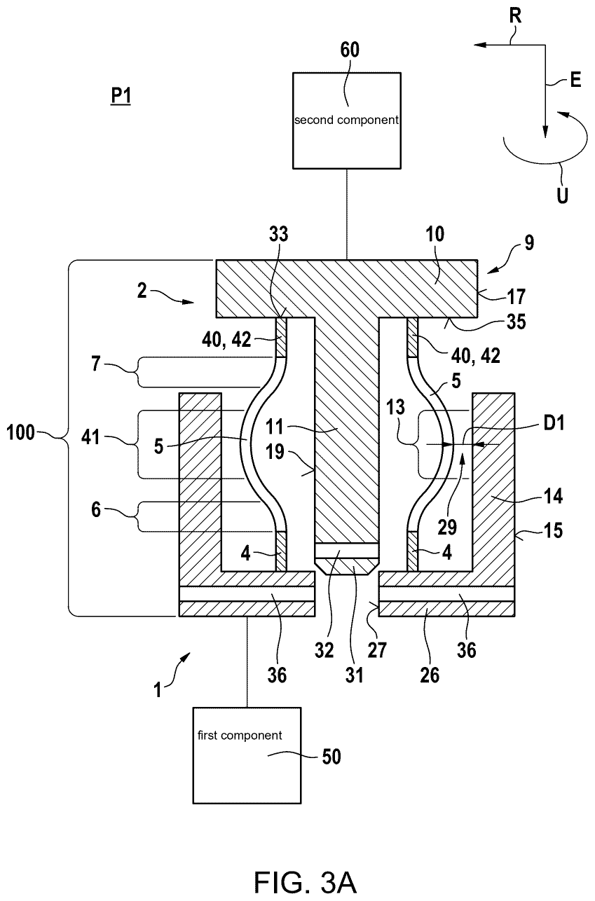

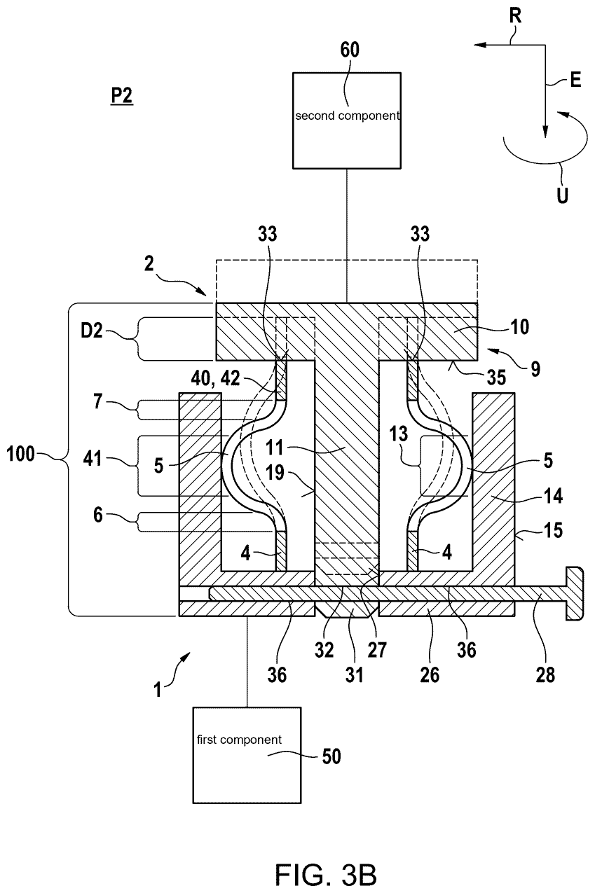

The mating plug-in connector 2 comprises a contact element 9 having a bottom side 35 facing the lamella cage 3. The mating plug-in connector 2 and/or the contact element 9 can, in particular when plugged together with the plug-in connector 1, be displaced between a first position P1 and a second position P2 (see FIG. 3A, 3B, 4A, 4B, 5A, 5B), in particular along the insertion direction E. At least up to the first position P1 (see FIG. 3A, 5A), the mating plug-in connector 2 and/or the contact element 9 can be displaced along the insertion direction E with a force of less than 5 N, in particular in a force-free manner. In the second position P2 (see FIG. 3B, 4A, 4B, 5B), the contact element 9 mechanically contacts the coupling section 42 of the lamella cage 3 in such a way that the contact-making sections 41 of the contact lamellae 5 are displaced along the radial direction R toward the outer wall 15 and the contact-making sections 41 as a result electrically contact a contact section 13 of the outer wall 15. They can clamp, e.g., the lamella cage 3 within the outer wall 15.

The first position P1 can be referred to, e.g., as a pre-contact position or intermediate plugging position—here, the contact element 9 can already be loosely in mechanical contact with the coupling element 42, e.g., resting against it or being arranged very close to the coupling element 42, e.g., less than 500 μm or less than 200 μm. The second position P2 can be referred to as the end contact position or final plugging position, in which the electrical connection is formed in the target state. A position as shown in FIG. 1 can be described as a pre-plugging position, in which, e.g., the first position has not yet been reached.

The contact chamber 14 can, e.g., be electrically connected to the first component 50. Depending on the embodiment, it can also be mechanically connected to the first component 50, e.g., by a press-fit connection and/or a soldered connection or the like. The lamella cage 3 can, e.g.—in the first position P1—be arranged loosely in the contact chamber 14, e.g., with play or a gap 29 (see FIG. 3A, 5A) toward the outer wall 15.

The first component 50 can be designed, e.g., as a printed circuit board 51 or as a current collecting rail or a so-called “busbar.” It can also be directly connected to an electrical power unit, e.g., an inverter, an AC/DC converter, a battery, an electrical machine or the like, or be designed as such a power unit. Thus, a particularly simple embodiment of a plug-in connector 1 is shown here. It is understood that in other embodiments the plug-in connector 1 can also comprise a plug-in connector housing in which the lamella cage 3 is arranged.

Here, the contact element 9 has, e.g., a head element 10. It further comprises merely by way of example a centering part 11 with a (front) end 31 protruding therefrom in the direction of the lamella cage 3, wherein the centering part 11 can be omitted in other embodiments; it is not absolutely necessary here for electrical contacting. The (front) end 31 of the centering part 11 is designed here merely by way of example as a cantilevered end. In this exemplary embodiment, the contact element 9 comprises a mushroom shape (a T-shape in longitudinal section). The centering part 11 preferably serves for radial centering of the contact element 9 relative to the lamella cage 3. It can (see FIG. 3A, 3B) also serve to radially stabilize the contact element 9 in the second position P2. In principle, it can be made of an insulating material.

The contact element 9 is, here by way of example, electrically connected to a second component 60, e.g., directly as shown here or via a line or via a busbar, etc. The second component 60 can, e.g., be designed as a further power unit, e.g., as an inverter, an electrical machine, a battery, etc. However, the second component 60 can also be a printed circuit board or a line that is connected to the further power unit.

The second position P2 can be reached starting from the first position P1, e.g., by an axial force acting on the contact element 9, in particular along the insertion direction E. The lamella cage 3 is mechanically contacted by this axial application of force or the axial pressure of the contact element 9 or the head part 10 or its bottom side 35, and the contact lamellae 5 deviate at least partially (in particular in the radial direction R) toward the outer wall 15 under this application of force. As a result, the contact lamellae 5 in the contact section 13 are pressed against the outer wall 15. The lamella cage 3 is compressed.

Thus, in the second position P2, a contacting arises between the lamella cage 3 and the contact chamber 14 by the contact-making sections 41 of the contact lamellae 3, thus providing a reliable electrical connection between the lamella cage and the plug-in connector 1 or the first component 50. At the same time, due to the coupling section 42, a reliable and good electrical connection to the contact element 9 and thus to the mating plug-in connector 2 and to the second component 60 is effected.

The lamella cage 3 can be made, e.g., of an electrically highly conductive material such as, e.g., copper or a copper alloy. The contact lamellae 5 can be designed to be elastically reversible with respect to the displacement of the contact element 9 from the first position P1 to the second position P2. This means that when the contact element 9 is displaced back from the second position P2 to the first position P1 or even further, the contact lamellae 5 are displaced back (approximately) to their initial position, which they had assumed in the force-free initial state. Subsequently, a new plugging process can take place, which in the second position P2 of the contact element 9 again leads to a displacement of the contact lamellae 5 radially toward the outer wall 15 of the contact chamber 14 and to an electrical contacting of said lamellae.

The insertion direction E can also be defined as the direction given by the displacement direction of the contact element 9 when contacting the lamella cage 3.

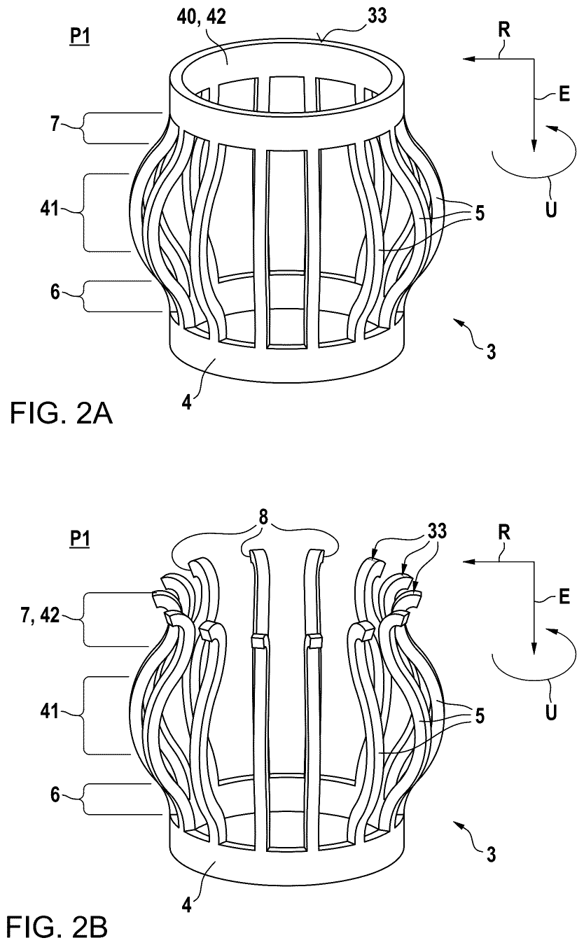

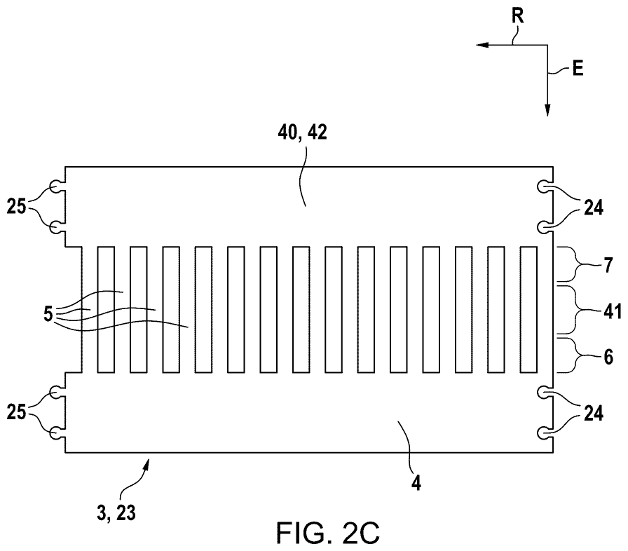

In FIGS. 2A and 2B, perspective schematic views of two different lamella cages 3 of a plug-in connector 1 are shown.

FIG. 2A shows a lamella cage 3 similar to what is shown in FIG. 1 in which the contact lamellae 5, starting from the base element 4, first pass into a rear section 6, from there into the contact-making section 41, from there into the front section 7 and from there into the head element 40. In the rear section 6, the contact lamellae 5 are connected to the base element 4. In the front section 7, the contact lamellae 5 are connected to the head element 40. The head element 40 and the base element 4 are, here by way of example, closed in a ring shape. By way of example, they can comprise a circular, elliptical or polygonal cross section (here: circular). The contact-making sections 41 of the contact lamellae 5 are clearly visible as being bulged radially outward (toward the outer wall 15 of the contact chamber 14 not shown here). This bulging effects that the contact lamellae 5 bulging further outward in the event of axial compression of the lamella cage 3 and are not indifferent with respect to a possible radially inner and radially outer warping.

Due to the closed design of the lamella cage 3 at both distal ends (base element 4 and head element 40), an axial pressure on the coupling section 42, which is formed here by way of example by the head element 40, can be distributed particularly evenly over the contact lamellae 5. Another advantage of this is that during transport and handling of the lamella cages 3 as individual components in production, the risk of the lamella cages 3 becoming caught between each other or damaging each other (e.g., as bulk material) is reduced.

FIG. 2B shows a lamella cage 3 similar to the one from FIG. 2A, in which, however, the contact lamellae 5 comprise free ends 8 in their front section 7. Thus, the coupling section 42 is formed here by the front section 7 of the contact lamellae 5.

The free ends 8 form the end face 33 here by way of example. The lamella cage 3 shown in FIG. 2B is particularly easy to produce. The shape of the free end 8, which is slightly bent radially outward, advantageously prevents the free ends 8 from digging into the bottom side 35 when axial force is applied by the contact element 9. A sliding surface is provided which particularly easily converts the axial force into a radial movement of the contact lamellae 5 toward the outer wall 15 (here: radially outward).

FIG. 2C shows a top view of a stamped sheet as the initial state for a lamella cage 3 as shown in FIGS. 1 and 2A, i.e., with the base element 4 and the head element 40. Thus, this is ultimately a two-dimensional precursor to the lamella cage 3.

In FIG. 2C on the lower side, one can see the base element 4 and the majority of the contact lamellae 5 protruding upward therefrom. The head element 40, to which the contact lamellae 5 are connected, is arranged on the upper side. On the left side of the base element 4 and the head element 40 in FIG. 2C, two pins 25, which are round here by way of example, can be seen and are connected to the base element 4 by means of a neck region having a smaller diameter. On the right side of the base element 4 and the head element 40 in FIG. 2C, two recesses 24 complementary to the pins 25 (also with a neck region) can be seen. In order to design the lamella cage 3, this two-dimensional punching form can first be pressed or embossed, e.g., in such a way that the desired course of the contact lamellae 5 is obtained (e.g., the contacting regions or contact-making sections 41 that bulge radially outward). Subsequently, the lamella cage 3 can be formed by a winding process, wherein the pins 25 are latched or inserted into the recesses 24 and the lamella cage 3 is held in a dimensionally stable manner by means of the form-fitting connection of the base element 4 and the head element 40 formed here. In other embodiments, the base element 4 and/or the head element 40 can be connected by a material bond (e.g., soldered, welded, glued, etc.). In still other embodiments, the base element 4 and/or the head element 40 can simply be wound and/or embossed, e.g., so that it/they automatically maintain(s) the specified shape, e.g., is/are formed in a closed ring shape.

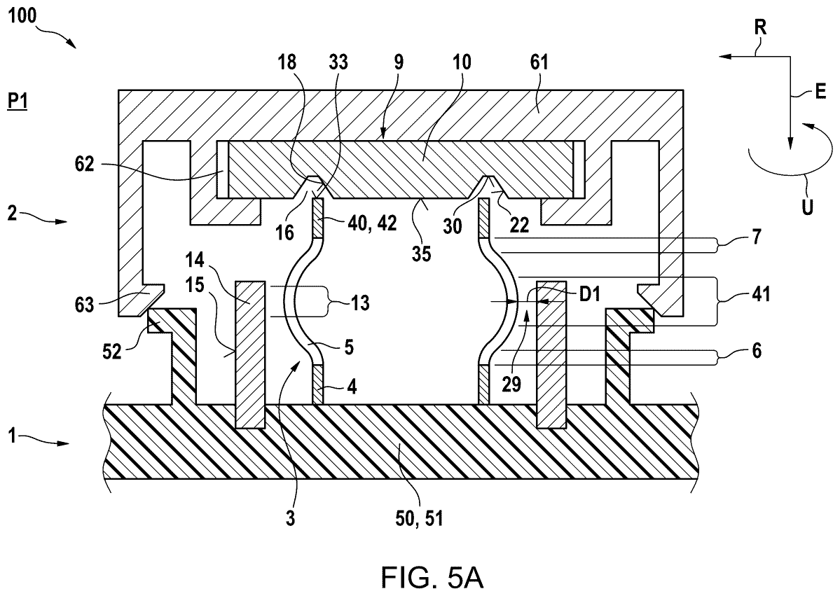

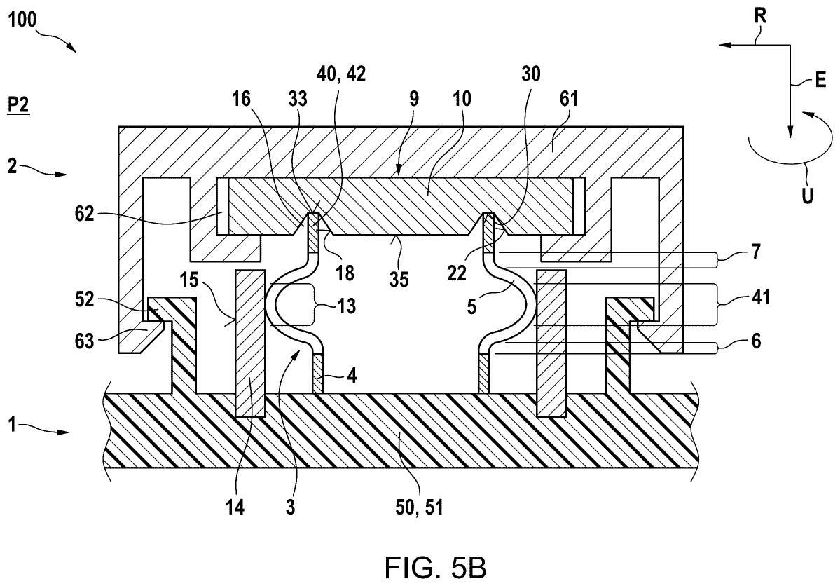

FIG. 3A to 5B show schematic cross sections through various plug-in connector arrangements 100. The mating plug-in connector 100 or the contact element 9 is shown in the first position P1 (FIGS. 3A and 5A) or in the second position P2 (FIGS. 3B, 4A, 4B and 5B). One contact lamella 5 can be seen to the left and one to the right of the centering part 11, which is provided here merely by way of example. The centering part 11 comprises a centering part outer wall 19.

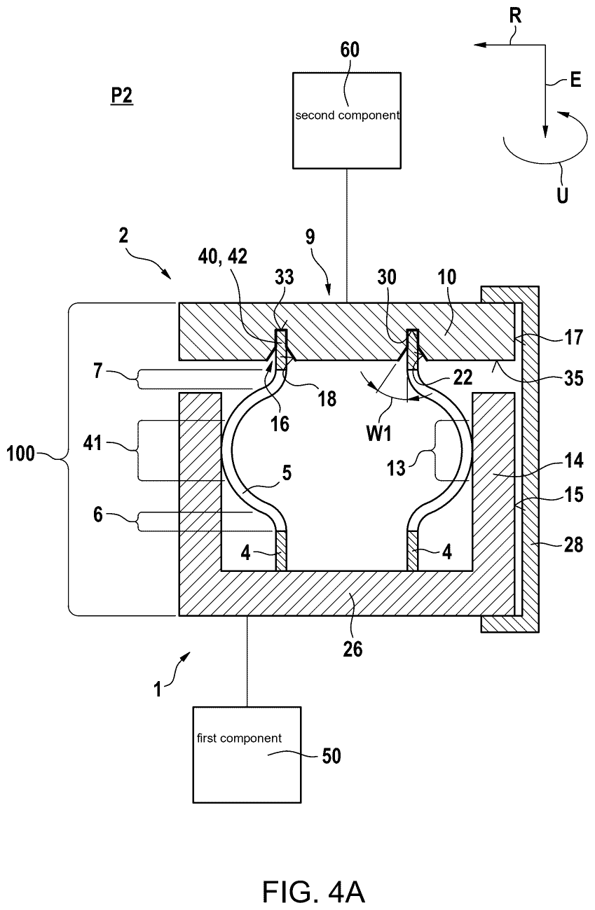

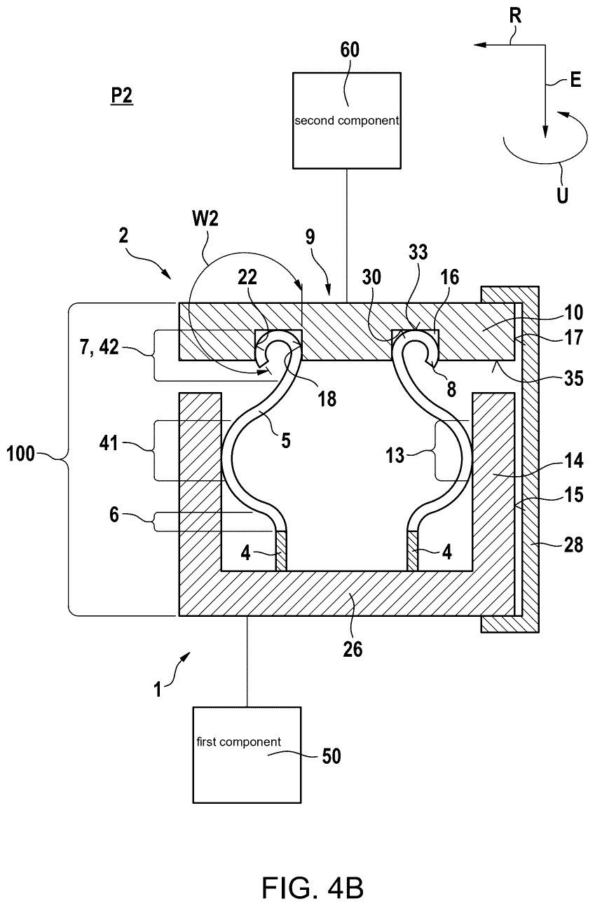

The lamella cage 3 is formed e.g., in FIGS. 3A, 3B, 4A, 5A and 5B similarly to the one from FIGS. 1 and 2A (with the head element 40). The lamella cage 3 of FIG. 4B is formed similarly to the one in FIG. 2B (without the head element the 40, with free ends 8), wherein its free ends 8 can even be bent outward. In principle, in all exemplary embodiments, lamella cages similar to those in FIG. 2A or similar to FIG. 2B can be used.

In all embodiments shown, the lamella cage 3 can be arranged, by way of example, in the first position P1 loosely or with radial play in the contact chamber 14.

Furthermore, it can be seen schematically how the first component 50 is electrically connected to the plug-in connector 1 and how the second component 60 is electrically connected to the mating plug-in connector 2. In FIG. 3A to 5B as well for reasons of clarity, no actuating element for reducing the insertion force is shown, even if such an actuating element (e.g., a lever element, a slide element or the like) can be provided optionally.

The contact element 9 comprises in the exemplary embodiment of FIGS. 3A and 3B on the bottom side 35 thereof, facing the coupling section 42 of the lamella cage 3, a substantially planar or flat or smooth surface.

In other exemplary embodiments, a groove 16, in particular a circumferential one, can be provided in or on the bottom side 35 (see e.g., FIGS. 4A, 4B, 5A and 5B). In this case, such a groove 16 can, merely by way of example, comprise a funnel shape in cross section having an initially obliquely running groove inner wall 18 and groove outer wall 22, wherein the groove inner wall 18 and groove outer wall 22 then run substantially parallel and/or perpendicular to the groove bottom 30, e.g., in the manner of a “Y” shape (see FIG. 4A). In particular, the groove inner wall 18 can, e.g., comprise a first angle W1 with respect to the insertion direction E, which is different from zero. For example, the first angle W1 of the groove inner wall 18 with respect to the insertion direction E can be in a range between 2° and 45° or in a range between 3° and 15°.

Or the groove 16 can, e.g., comprise a substantially vertical groove outer wall 22 and a substantially vertical groove inner wall 18, e.g., in the manner of a “U” shape or a rectangular shape (see FIG. 4B), or the groove 16 can comprise a groove outer wall 22 and a groove inner wall 18, which each run completely obliquely (i.e., e.g., each comprise an angle not equal to 0° relative to the axial direction), e.g. in the manner of a “V” shape (see FIGS. 5A and 5B).

In principle, it is also possible that such a groove 16 comprises a semi-funnel shape, wherein in particular the groove inner wall 18 runs obliquely at least in sections (and has, e.g., a first angle W1 as described above). Such a slope not only allows radial centering of the contact element 9 and facilitates insertion. Alternatively or additionally, the slope of the groove inner wall 18 allows the coupling region 42 to be displaced radially toward the outer wall 15 on the path from the first position P1 to the second position P2 in the manner of a slotted guide. This supports the application of the contact normal force to the outer wall 15 in addition to the compression of the contact lamellae 5 in the radial direction toward the outer wall 15.

Furthermore, it is also possible, e.g., that the bottom side 35 is convexly curved, i.e., is higher at the edge 17 than in the middle region. In such a case, it can, e.g., form a continuous surface without jumps (such as, e.g., through a groove 16).

FIG. 3A shows the first position P1 when plugging together plug-in connector 1 and mating plug-in connector 2. The contact element 9 here comprises a centering part 11, which already overlaps to a very large extent (almost 100%) with the lamella cage 3 (overlap along the insertion direction E). The bottom side 35 of the contact element 9 rests loosely against or on the end face 33, in this case on the head element 40, which serves, here by way of example, as a coupling section 42. No or only a small axial force (e.g., only the force of gravity) is exerted by the contact element 9 on the coupling section 42 and thus on the contact lamellae 5. It is also possible that in the first position P1 the bottom side 35 is still somewhat spaced apart (e.g., between 1 μm and 500 μm, preferably between 1 μm and 200 μm) from the end face 33 of the coupling section 42, so that no force is exerted in the axial direction.

The contact chamber 14 also comprises. here by way of example, a bottom 26. Arranged in the bottom 26 of the contact chamber 14 is a bottom recess 27 into which, by way of example, a front end 31 of the centering part 11 (here: a cantilevered end of the centering part 11) can be inserted (e.g., in the second position P2, see FIG. 3B). In this way, e.g., with the aid of the centering part 11, the correct radial positioning of the contact element 9 in the second position P2 can be ensured or the positioning tolerances can be reduced when they are plugged together.

In FIG. 3A it can also be seen that at least up to the first position P1 the mating plug-in connector 2 or the contact element 9 can be displaced along the insertion direction E with a force of less than 5 N, in particular in a force-free manner, since up to the first position P1 no friction and also no snap forces, etc. occur between the contact element 9 and the lamella cage 3, although a large part of the insertion path has already been covered. Furthermore, it can be seen that in the first position P1 a radial play is formed between the contact lamellae 5 and the outer wall 15 of the contact chamber 14, here in the form of a gap 29.

The force-free displacement or the displacement with a force of less than 5 N refers in particular to forces that are necessary to overcome frictional forces, snap forces, etc. Overcoming gravity, e.g., in the case of overhead installation, should not be taken into account here.

In the first position P1, here by way of example, the radial play between the contact lamellae 5 and the outer wall 15 is in a range between 5 μm and 200 μm or in a range between 20 μm and 100 μm, e.g., at 20 μm or at 30 μm or at 40 μm or at 50 μm or at 60 μm or at 70 μm or at 80 μm or at 90 μm or at 100 μm or at 130 μm or at 160 μm or at 200 μm. In other words: the gap 29 effects the radial play and establishes a first distance D1 (in radial direction R) in the range described above (e.g., between 5 μm and 200 μm, etc.).

FIG. 3B shows the contact element 9 in the second position P2 (solid lines—the previous first position P1 from FIG. 3A is shown with dashed lines). The front end 31 of the centering part 11 is inserted into the bottom recess 27 of the bottom 26 of the contact chamber 14 or is arranged in the bottom recess 27. For this purpose, the bottom recess 27 can, e.g., comprise a particularly slight oversized dimension (e.g., up to 500 μm, preferably up to 250 μm) compared to the front end 31. However, a press fit can also be formed, i.e., the front end 31 comprises an, in particular, slightly oversized dimension with respect to the diameter of the bottom recess 27. In this way, the contact element 9 is guided and/or secured in the radial direction 9, as a result of which a permanent and reliable contacting is advantageously ensured even under adverse operating conditions (e.g., vibration loads, thermal cycling loads, etc.).

The first position P1 and the second position P2 are, here by way of example, spaced apart along the insertion direction E by a maximum of 5 mm, preferably by a maximum of 2 mm and most preferably by a maximum of 1 mm.

In other words, the second position P2 is spaced apart from the first position P1 by a second distance D2 (viewed along the insertion direction E).

In the second position P2, the contact element 9 mechanically contacts the coupling section 42 of the lamella cage 3 in such a way that the contact lamellae 5 are displaced along the radial direction R toward the outer wall 15 and the contact-making sections 41 as a result electrically contact the contact section 13 of the outer wall and in particular clamp the lamella cage within it (in particular viewed along the radial direction R).

In other words: the contact element 9 presses or exerts pressure by means of its bottom side 35 onto the end face 33 of the coupling section 42, as a result of which the contact lamellae 5 deflect or tilt or are tilted or displaced or are displaced radially outward or toward the outer wall in the radial direction R. As a result, the outer wall 15 in the contact section 13 is subjected to a contact normal force by means of the contact-making sections 41 of the contact lamellae 5, which, here by way of example, acts substantially in the radial direction R.

In this embodiment, by way of example, in the second position P2 the contact lamellae 5 contact the contact section 13 with a contact normal force in the radial direction R of at least 1 N, preferably of at least 5 N.

In addition to the contacting within the plug-in connector 1 (from the lamella cage 3 to the contact chamber 14), in the second position P2 an electrical contacting is also established between the plug-in connector 1 and the mating plug-in connector 2, which leads via the end face 33 of the coupling section 42 to the bottom side 35 of the head section 10 of the contact element. This contacting substantially runs along the axial direction.

Purely schematically, in FIGS. 3A and 3B an optional locking element 28 is further shown, which secures the second position P2 against loosening. The locking element 28 is shown here merely symbolically or schematically as a type of slider which, in the second position P2, can be guided through locking recesses 36 in the bottom 26 of the contact chamber 14 and, in the region of the bottom recess 27, passes through a recess 32 in the centering part 11.

FIG. 4A shows a schematic cross section through a further plug-in connector arrangement 100 in the second position P2, wherein this plug-in connector arrangement 100 is designed similarly to that of FIG. 3B.

In contrast to FIGS. 1, 3A and 3B, however, no centering part 11 is provided on the contact element 9, even if a centering part could be provided optionally (as in FIG. 1, 3A, 3B, the centering part 11 could also be optionally omitted). The contact element 9 here only comprises the head section 10.

The plug-in connector arrangement 100 of FIG. 4A however, as a result differs from that of FIG. 3B among other things in that a groove 16 is introduced into the bottom side 35 of the contact element 9 on the side facing the lamella cage 3. As a result, e.g., the end face 33 of the coupling section 42 can be advantageously captured and thus arranged in the correct radial position on or in the bottom side 35, e.g., already in the first position P1. If in an exemplary embodiment not shown here in which the lamella cage 3 does not comprise a head element 40 one or more contact lamellae 5 are damaged or bent, i.e., e.g., if the end face 33 is not in the correct radial position, or if the contact element 9 is placed slightly radially offset, then advantageously a (particularly radial) self-centering of the bent contact lamella(e) 5 in the groove 16 can be carried out and/or a radial self-centering of the contact element 9 can be carried out. If there is a significant bending of one or more contact lamellae 5, the contact element 9 can be tilted, since some contact lamellae 5 are caught in the groove 16, but others are outside on the bottom side 35. Such a misalignment can serve to indicate a problem to a technician or a machine. The assembly quality can thus be advantageously improved.

In the second position P2, the coupling section 42, in this case the head element 40, is arranged in the groove 16.

Due to the funnel shape of the groove 16 shown here, the coupling section 42 is electrically contacted in the second position P2 on at least two sides, e.g., the groove inner wall 18 and the groove outer wall 22. In this embodiment, the coupling section 42 in the second position is even electrically and mechanically contacted on three sides: on the groove bottom 30 (in the axial direction) and on the groove inner wall 18 and groove outer wall 22 (each in the radial direction R).

The optional locking element 28 for securing the second position P2 is designed here merely by way of example as a type of clamp which clamps the contact element 9 and the contact chamber 14 together and thus secures the plug-in connector 1 and the mating plug-in connector 2 against being displaced from each other.

FIG. 4B shows a schematic cross section through a further plug-in connector arrangement 100 in the second position P2, wherein this plug-in connector arrangement 100 is formed similarly to that of FIG. 4A, i.e., it comprises a groove 16 in the head section 10.

In this embodiment as well, the contact element 9 does not comprise a centering part 11, even though it could be provided optionally.

Here, however, the groove 16 comprises a substantially rectangular cross section (e.g., similar to a U-shape). In addition, the lamella cage 3 here, by way of example, does not comprise a head element 40, but rather the contact lamellae 5 are formed with free ends 8 in their front section 7.

It can also be seen that in this exemplary embodiment the contact lamellae 5 in the front section 6 are bent outward in the radial direction R (or in the direction of the outer wall 15, wherein the outer wall 15 is not as high as the lamella cage 3). Here by way of example, they are bent relative to the insertion direction E by a second angle W2, which is, here by way of example, somewhat larger than 180° and can be, merely by way of example, in a range between 185° and 260°. In other exemplary embodiments the second angle W2 can also be omitted entirely, or it can, e.g., be at least 30°, preferably at least 60° and particularly preferably at least 110°.

In this exemplary embodiment, in the second position P2 the contact lamellae 5 are arranged with their front sections 6 in the groove 16, wherein the front sections form, here by way of example, the coupling section 42. In this way, the contact lamellae 5 are advantageously protected against (radially) slipping out of the contact position, e.g., even in the event of strong vibration loads or alternating thermal loads. Thus, it cannot easily happen that the end face 33 is displaced radially outward for a short time (e.g., due to an impact) the contact lamella 5 as a result changing its bending (e.g., into a bistable second state, in which the contact lamella 5 folds over radially inward at the level of the contact section 13).

In this exemplary embodiment, the contact lamellae 5 contact the groove 16 on at least two sides. The at least two sides are preferably spaced apart from each other by at least 30° (this is understood to mean an angle in the illustrated image plane, not an angle along the circumferential direction U). A contact side is, here by way of example, the inner wall 18 of the groove. A further contact side is, here by way of example, the groove bottom 30. In this exemplary embodiment, the groove outer wall 22 is further contacted by the contact lamella 5. The front section 6 of the contact lamellae 5 is pressed together in the groove 16 due to the axial force applied by the contact element 9 in the second position P2 and fills the groove 16 in the second position P2 to a significantly greater extent than in the first position P1. In this way, the contact surface between contact lamellae 5 and contact element 9 is considerably enlarged, as a result of which the current carrying capacity of the plug-in connector arrangement 100 (significantly) increases and contact resistance decreases. Furthermore, the number of contact points is advantageously increased. This advantageously increases the redundancy at contact points, so that the plug-in connector arrangement 100 is better protected against failures.

The optional locking element 28 for securing the second position P2 is designed here merely by way of example, as in FIG. 4A, as a type of bracket.

In this exemplary embodiment, the groove 16 runs obliquely outward on the groove inner wall 18 toward the groove bottom 30. As a result, in addition to the radial tilting or displacement of the contact lamellae 5 caused by the axial force or compression (by the contact element 9), this displacement or tilting can be supplemented or supported by a form-fitting component. The oblique groove inner wall 18 acts in the manner of a link or a link guide, which, upon axial movement of the contact element 9 along the insertion direction E, effects a strictly defined radial displacement of the front section 7 of the contact lamellae 5 in the radial direction R toward the outer wall 15.

In this exemplary embodiment, the first angle W1 of the groove outer wall 22 with respect to the insertion direction E lies in a range between 2° and 45° (i.e., a range of 20-45°) or in a range between 3° and 15° (i.e., a range of 3°-15°).

As a result, when the contact element 9 is displaced from the first position P1 to the second position P2 (i.e., by a distance corresponding to the second distance D2, see FIGS. 3A and 3B) in addition to the axial force action, it is ensured that the contact lamellae 5 move by a defined distance in the radial direction R toward the outer wall 15 and that as a result the desired contact normal force in the contact section 13 of the outer wall 15 is applied by the contact lamellae 5 or the contact-making sections 41 thereof. Furthermore, it is ensured that a gap 29, which is optionally present in position P1 (see FIG. 3A), between contact lamellae 5 and outer wall 15 is closed. Furthermore, as a result a contact surface between the coupling section 42 and the contact element 9 is also advantageously enlarged and the electrical contact between the lamella cage 3 and the contact element 9 is thereby improved.

The optionally present locking element 28 is designed in the exemplary embodiment of FIG. 4B analogously to the locking element from FIG. 4A (as a type of bracket).

FIGS. 5A and 5B show schematic cross sections through a further plug-in connector arrangement 100 with the mating plug-in connector 2 in the first position P1 (FIG. 5A) or in the second position P2 (FIG. 5B).

The contact element 9 is received or arranged in a mating plug-in connector housing 61. It is mounted or arranged, here by way of example, at its head section 10 in a contact element chamber 62 and is preferably secured with respect to the axial direction. This type of storage can, e.g., also protect it from tipping over.

In the cross section shown, two locking elements 52 spaced apart from each other can be seen, which are arranged on the first component 50 and protrude from the first component 50 in the direction of the mating plug-in connector 2. The lamella cage 3 is arranged between them. The locking elements 52 comprise, here by way of example, undercuts.

In the cross section shown, two mating locking elements 63 can be seen on the mating plug-in connector housing 61, which protrude from the mating plug-in connector housing 61 in the direction of the plug-in connector 1 and each comprise a hook element. The mating locking elements 63 can be designed in the manner of (particularly along the radial direction R) elastically reversible locking lances or clip elements. The contact element 9 is arranged between the mating locking elements 63.

In the first position P1, shown in FIG. 5A, the mating locking elements 63 can rest on the locking elements 52 and thus, e.g., advantageously provide a technician with haptic feedback for reaching the first position P1. In other embodiments, it can be provided, e.g., that a captive connection between plug-in connector 1 and mating plug-in connector 2 is formed already when (or even before) the first position P1 is reached, so that the ensemble can be transported in this state.

The mating locking elements 63 can, here by way of example, slide past the undercuts of the locking elements 52 on the path from the first position P1 to the second position P2 (deflection radially outward in the exemplary embodiment shown) and can be elastically reversibly spring back into their initial position radially inward in the second position P2, so that they engage behind the undercuts of the locking elements 52 with their hook elements. In this way, an unintentional release of the contact element 9 from the second position P2 in the direction of the first position P1 is prevented. The locking elements 52 and the mating locking elements 63 thus form a type of locking element 28.

The lamella cage 3 is designed, here by way of example, analogously to the lamella cage from FIG. 2A. The bottom side 35 has, here by way of example, a groove 16 in which the groove inner wall 18 and the groove outer wall 22 are both designed to be oblique and converge toward each other. It is designed in a type of funnel shape. Here, the groove is designed in a “V” shape, for example.

The lamella cage 3 comprises in the first position P1 (FIG. 5A), by way of example, a radial play with respect to the outer wall 15; here, for example, a gap 29 is formed (with the first distance D1) between the outer wall 15 and at least one contact lamella 5. In the second position P2 (FIG. 5B) the contact lamellae 5 are in (mechanical) contact with the bottom side 35 or the groove 16 of the contact element 9 at or in their coupling section 42 (in this case: the head element 40). They are compressed by the application of axial force of the contact element (between the bottom side 35 and the base element 4 or between the head element 40 and the base element 4) and are as a result displaced in the radial direction R toward the outer wall 15, which they electrically contact in the contact section 13 and in particular apply a defined contact normal force. As a result, the lamella cage 3 can be clamped within the outer wall 15.

1-11. (canceled)

12. A plug-in connector arrangement, comprising:
a plug-in connector;
a mating plug-in connector for plugging together with the plug-in connector;
wherein the plug-in connector includes a lamella cage having a base element and a plurality of contact lamellae, wherein the contact lamellae:
are connected to the base element in a rear section,
protrude from the base element in a direction of the mating plug-in connector,
include a front section which faces the mating plug-in connector and: (i) which includes a cantilevered end or (ii) using which the contact lamellae are connected to a head element of the lamella cage, and
include a contact-making section arranged between the rear section and the front section;
wherein the lamella cage includes a coupling section,
wherein the plug-in connector includes a contact chamber having an outer wall,
wherein the lamella cage is arranged in the contact chamber,
wherein the contact-making sections are pre-bent in a direction of the outer wall in relation to the rear section and the front section,
wherein the mating plug-in connector includes a contact element having a bottom side facing the lamella cage,
wherein the contact element and/or the mating plug-in connector, when plugged together with the connector, can be displaced between a first position and a second position, along an insertion direction,
wherein at least up to the first position, the contact element and/or the mating plug-in connector can be displaced along the insertion direction with a force of less than 5 N,
wherein in the second position, the contact element mechanically contacts the coupling section of the lamella cage in such a way that the contact-making sections of the contact lamellae are displaced along a radial direction toward the outer wall and the contact-making sections as a result electrically contact a contact section of the outer wall and clamp the lamella cage within the outer wall.

13. The plug-in connector arrangement according to claim 12, wherein in the second position, the contact lamellae contact the contact section with a contact normal force in a radial direction of at least 1 N.

14. The plug-in connector arrangement according to claim 12, wherein the base element and/or the head element of the lamella cage is configured to be circumferentially closed.

15. The plug-in connector arrangement according to claim 12, wherein the first position and the second position are spaced apart along the insertion direction by at most 5 mm.

16. The plug-in connector arrangement according to claim 12, wherein in the first position, radial play between the contact-making section and the outer wall is in a range between 5 μm and 200 μm or in a range between 20 μm and 100 μm.

17. The plug-in connector arrangement according to claim 12, wherein:
a groove with an inner groove wall, a groove bottom, and an outer groove wall is introduced into the bottom side of the contact element for receiving the coupling section,
in the second position, the coupling section is arranged in the groove, and contacts the groove on at least two sides.

18. The plug-in connector arrangement according to claim 17, wherein in the second position, the mechanical contacting of the coupling section is made by the groove bottom.

19. The plug-in connector arrangement according to claim 17, wherein the groove inner wall, facing away from an outer edge of the bottom side, extends obliquely outward toward the groove bottom, and wherein a first angle of the groove inner wall with respect to the insertion direction lies in a range between 2° and 45° or in a range between 3° and 15°.

20. The plug-in connector arrangement according to claim 17, wherein the groove includes a funnel shape in cross section.

21. The plug-in connector arrangement according to claim 17, wherein in the second position, the coupling section is clamped between the groove inner wall and the groove outer wall, so that the coupling section electrically contacts both the groove inner wall and the groove outer wall.

22. A plug-in connector for plugging together with a mating plug-in connector including a contact element, the plug-in connector comprising:
a lamella cage having a base element and a plurality of contact lamellae, wherein the contact lamellae:
are connected to the base element in a rear section,
protrude from the base element in a direction of the mating plug-in connector,
a front section which faces the mating plug-in connector and: (i) which includes a cantilevered end or (ii) using which the contact lamellae are connected to a head element of the lamella cage,
a contact-making section arranged between the rear section and the front section;
wherein the lamella cage includes a coupling section,
wherein the plug-in connector includes a contact chamber having an outer wall,
wherein the lamella cage is arranged in the contact chamber,
wherein the contact-making sections are pre-bent in a direction of the outer wall in relation to the rear section and the front section, and
wherein the lamella cage is configured in such a way that when a force is applied along an insertion direction to the coupling section, by the contact element, the contact-making sections of the contact lamellae are displaced along a radial direction toward the outer wall and the contact-making sections as a result electrically contact a contact section of the outer wall and clamp the lamella cage within the outer wall.

23. The plug-in connector arrangement according to claim 12, wherein the plug-in connector arrangement is for high-current applications and/or high-voltage applications.

24. The plug-in connector according to claim 22, wherein the plug-in connector is for high-current applications and/or high-voltage applications.
